(19) United States
(12) Patent Application Publication
(10) Pub. No.: US 2011/0055443 A1
(43) Pub. Date: Mar. 3, 2011

(54) MEMORY CONTROL APPARATUS AND INFORMATION PROCESSING APPARATUS INCLUDING THE SAME

(75) Inventors: Yoshiharu WATANABE, Osaka (JP); Daisuke MURAKAMI, Kyoto (JP)

(73) Assignee: PANASONIC CORPORATION, Osaka (JP)

(21) Appl. No.: 12/941,499

(22) Filed: Nov. 8, 2010

Related U.S. Application Data
(63) Continuation of application No. PCT/JP2009/001533, filed on Apr. 1, 2009.

(30) Foreign Application Priority Data
May 13, 2008 (JP) 2008-125555

(51) Int. Cl. G06F 13/14; G06F 12/00

(52) U.S. Cl. 710/240; 711/154; 711/E12.001

(57) ABSTRACT

Provided is a memory control apparatus including: a monitoring unit that monitors, for each of the masters, a usable bandwidth indicating an amount of memory access data to be accessed per unit time in response to a corresponding one of the access requests from the master; a holding unit that holds a predetermined request bandwidth for each of the masters; a bandwidth determining unit that determines whether or not the usable bandwidth has reached the predetermined request bandwidth for each of the masters; and a control unit that issues an advanced refresh command to the memory based on a result of the determination by the bandwidth determining unit for each of the masters, regardless of timing of a refresh cycle.

### CROSS REFERENCE TO RELATED APPLICATION

This is a continuation application of PCT application No. PCT/JP2009/001533 filed on Apr. 1, 2009, designating the United States of America.

### BACKGROUND OF THE INVENTION

(1) Field of the Invention

The present invention relates to a memory control apparatus and an information processing apparatus including the same. The memory control apparatus is connected to a plurality of masters and a memory shared by the masters, and controls access from the masters to the memory in response to access requests issued by the masters.

(2) Description of the Related Art

In system LSIs, Uniform Memory Access (UMA) is known as a technique for masters, such as a processor and a hardware engine, to access shared memories. The memories to be used here include a Synchronous Dynamic Random Access Memory (SDRAM). The SDRAM is a volatile memory, and thus requires refresh operations of injecting charges at intervals to hold data. For a predetermined period of time before and after the refresh operations on the SDRAM, no access to the SDRAM is allowed according to the specification of the SDRAM. With the refresh operations, access requests from the masters to the SDRAM are temporarily suspended, thus reducing the efficiency of access from the masters to the SDRAM.

As a conventional technique for improving the access efficiency, for example, Japanese Unexamined Patent Application Publication No. 6-236683 (hereinafter referred to as Patent Reference 1) discloses a memory refresh control circuit. The memory refresh control circuit in Patent Reference 1 issues refresh commands in advance prior to periodical refresh command issuance intervals, when a host CPU does not issue an access request to a memory. While the host CPU issues an access request to the memory, when the memory refresh control circuit issues refresh requests in synchronization with the periodical refresh command issuance intervals, the following processing is performed. When the memory refresh control circuit previously issues the refresh commands in advance, it suspends the issuance of the refresh commands in response to the refresh requests. Since the access request from the host CPU to the memory is not interrupted, the efficiency of access from the host CPU to the memory is improved.

Although the efficiency of access from the host CPU to the memory can be improved, the masters do not share a memory in the configuration according to Patent Reference 1. With the configuration in which the masters share the memory, only when none of the masters issues the access requests, the memory refresh control circuit can issue the refresh commands in advance as disclosed in Patent Reference 1. However, since the situation where none of the masters issues the access requests less frequently occurs, there is a problem that the effect of improving the access efficiency diminishes.

The present invention has been conceived in view of the problem, and has an object of providing a memory control apparatus and an information processing apparatus including the same for improving the efficiency of access from masters to a memory by issuing refresh commands in advance even when the memory is shared by the masters.

### SUMMARY OF THE INVENTION

In order to solve the problem, a memory control apparatus according to an aspect of the present invention is a memory control apparatus connected to a plurality of masters that issue access requests and to a memory shared by the masters, the memory control apparatus controlling access from the masters to the memory in response to the access requests, and includes: a monitoring unit configured to monitor, for each of the masters, a usable bandwidth indicating an amount of memory access data to be accessed per unit time in response to a corresponding one of the access requests from the master; a holding unit configured to hold a predetermined request bandwidth for each of the masters; a bandwidth determining unit configured to determine whether or not the usable bandwidth has reached the predetermined request bandwidth for each of the masters; and a control unit configured to issue an advanced refresh command to the memory based on a result of the determination by the bandwidth determining unit for each of the masters, regardless of timing of a refresh cycle.

Thereby, since the advanced refresh command is issued to the memory shared by the masters, based on the usable bandwidth and the request bandwidth, the efficiency of access to the memory due to the issuance of the refresh command in synchronization with a refresh cycle can be further improved.

Furthermore, the control unit may be configured to: determine, when the bandwidth determining unit determines that the usable bandwidth has reached the predetermined request bandwidth, that a corresponding one of the masters does not assert the access request; and issue the advanced refresh command to the memory when determining that none of the masters asserts the access requests.

Thereby, since the advanced refresh commands issued with the configuration can be larger than the advanced refresh commands issued only when none of the masters issues the access requests to the memory, the efficiency of access to the memory can be further improved.

Furthermore, the control unit may include: a normal refresh control unit configured to periodically issue, to the memory, a normal refresh command for refreshing the memory; and a number-of-refresh-issuance counter that decrements a count value by 1 for each refresh cycle, increments a count value by 1 when the normal refresh control unit issues the normal refresh command, and increments a count value by 1 when the control unit issues the advanced refresh command, and the normal refresh control unit may be configured: to issue the normal refresh command when the count value of the number-of-refresh-issuance counter becomes a reference value; and not to issue the normal refresh command when the count value of the number-of-refresh-issuance counter is not the reference value.

Thereby, the number of advanced refresh commands issued prior to a period when no normal refresh command is issued is not smaller than the number of normal refresh commands that should be issued during the time. As a result, volatilization of data due to the lack of refresh can be prevented.

Furthermore, the control unit may be configured to prohibit the issuance of the advanced refresh command when the count value of the number-of-refresh-issuance counter is equal to or larger than a threshold larger than the reference value.

Thereby, the memory control apparatus issues a normal refresh command at least once within a time period corresponding to the threshold and a refresh cycle. As a result, volatilization of data due to the lack of refresh in a memory for a long period of time can be further prevented.

Furthermore, the control unit may includes: a refresh request issuing unit configured to periodically issue a normal refresh request for refreshing the memory; and an arbitrating unit configured to arbitrate between the normal refresh request and each of the access requests issued by the masters, based on (i) a difference between the usable bandwidth and the predetermined request bandwidth for each of the masters and (ii) a refresh request bandwidth indicating an amount of memory access data to be accessed per unit time in response to the normal refresh request from a corresponding one of the masters, and to issue a command to the memory according to a result of the arbitration.

Thereby, when two or more of the access requests are respectively issued from the masters, the memory control apparatus can arbitrate between the access requests. Furthermore, when a normal refresh request is issued during a period of issuance of at least one access request from each of the masters, the memory control apparatus can arbitrate between the access request and the normal refresh request.

Furthermore, an information processing apparatus according to an aspect of the present invention includes: a semiconductor integrated circuit including the memory control apparatus and the masters; and the memory connected to the semiconductor integrated circuit and requiring a refresh operation, and the masters including: a first master that writes externally provided coded data into the memory; a second master that decodes the coded data written into the memory and writes the decoded data into the memory; and a third master that obtains the decoded data from the memory and provides the obtained decoded data to a display.

Furthermore, the first master may write the coded data separate from digital broadcast waves into the memory.

Furthermore, the coded data may be data including a picture.

Furthermore, the information processing apparatus may further include: an image sensor that images an object and provides imaging data; and a fourth master that writes the provided imaging data into the memory, wherein the second master may further obtain the imaging data from the memory, code the obtained imaging data, and write the coded imaging data into the memory, the third master may further obtain the imaging data from the memory, and provide the obtained imaging data to a display, and the first master may obtain the coded imaging data from the memory, and record the obtained coded imaging data onto a recording medium.

According to an aspect of the present invention, provided is a memory control apparatus and an information processing apparatus that can improve the efficiency of access from masters to a memory by issuing refresh commands in advance even when the memory is shared by the masters.

### FURTHER INFORMATION ABOUT TECHNICAL BACKGROUND TO THIS APPLICATION

The disclosure of Japanese Patent Application No. 2008-125555 filed on May 13, 2008 including specification, drawings and claims is incorporated herein by reference in its entirety.

The disclosure of PCT application No. PCT/JP2009/001533 filed on Apr. 1, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 illustrates a configuration of a memory control apparatus according to Embodiment 1 in the present invention;

FIG. 2 is a block diagram illustrating a detailed configuration of an access request arbitrating unit;

FIG. 3 is a block diagram illustrating an example of a detailed configuration of a usable bandwidth monitoring unit;

FIG. 4 is a block diagram illustrating a detailed configuration of a refresh request issuing unit;

FIG. 5 illustrates a timing chart indicating an example of operations of the memory control apparatus;

FIG. 6 is a block diagram illustrating a detailed configuration of a refresh request issuing unit according to Embodiment 2;

FIG. 7 illustrates a timing chart indicating an example of operations of the memory control apparatus;

FIG. 8 is a block diagram illustrating a configuration of a system according to Embodiment 3;

FIG. 9 is a block diagram illustrating a configuration of a system according to Embodiment 4; and

FIG. 10 is a block diagram illustrating a configuration a digital camera including the memory control apparatus according to the present invention.

### DESCRIPTION OF THE PREFERRED EMBODIMENTS

### Embodiment 1

An memory control apparatus according to Embodiment 1 is a memory control apparatus connected to a plurality of masters that issue access requests and to a memory shared by the masters, the memory control apparatus controlling access from the masters to the memory in response to the access requests, and includes: a monitoring unit configured to monitor, for each of the masters, a usable bandwidth indicating an amount of memory access data to be accessed per unit time in response to a corresponding one of the access requests from the master; a holding unit configured to hold a predetermined request bandwidth for each of the masters; a bandwidth determining unit configured to determine whether or not the usable bandwidth has reached the predetermined request bandwidth for each of the masters; and a control unit configured to issue an advanced refresh command to the memory based on a result of the determination by the bandwidth determining unit for each of the masters, regardless of timing of a refresh cycle.

Thereby, since the advanced refresh command is issued to the memory shared by the masters, based on the usable bandwidth and the request bandwidth, the efficiency of access to the memory due to the issuance of the refresh command in synchronization with a refresh cycle can be further improved.

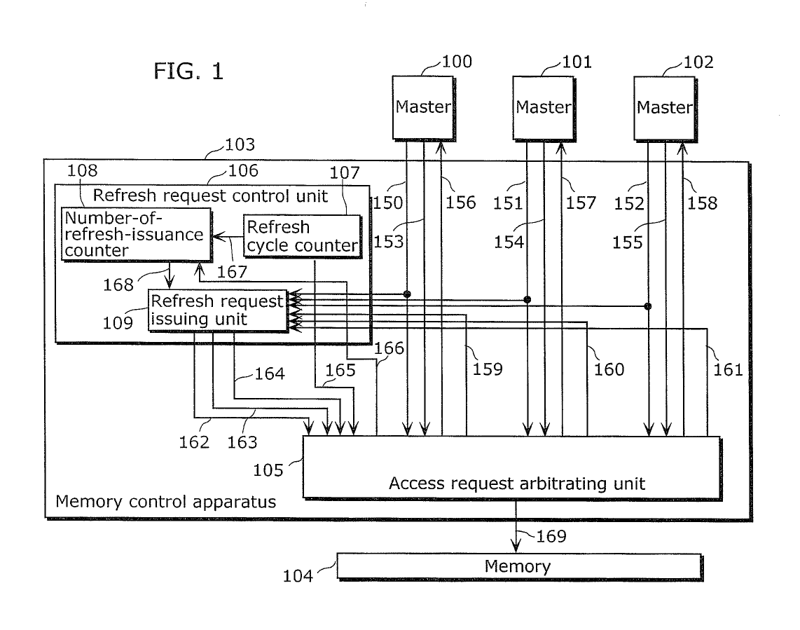

FIG. 1 illustrates a configuration of a memory control apparatus 103 according to Embodiment 1 in the present invention. FIG. 1 also illustrates masters 100 to 102 and a memory 104 connected to the memory control apparatus 103.

The memory control apparatus 103 includes an access request arbitrating unit 105 and a refresh request control unit 106, arbitrates between access requests 150 to 152 from the masters 100 to 102 to the memory 104, and controls the issuance of an access command to the memory 104. Furthermore, the memory control apparatus 103 controls the issuance of a refresh command to the memory 104.

The access request arbitrating unit 105 arbitrates between the access requests 150 to 152 issued respectively from the masters 100 to 102 to the memory 104 so as to satisfy a request bandwidth to the memory 104 that is determined in advance for each of the masters 100 to 102. Next, the access request arbitrating unit 105 issues, according to a result of the arbitration, one of access commands 153 to 155 to the memory 104 through a command communication signal line 169. Each of the access commands 153 to 155 includes a distinction between write and read, a type of the master, an access address, and an access data amount. The access request arbitrating unit 105 notifies the masters 100 to 102 of the result of the arbitration using access request enabling signals 156 to 158, respectively. Furthermore, the access request arbitrating unit 105 monitors usable bandwidths of the masters 100 to 102, based on the access commands 153 to 155 from the masters 100 to 102 to the memory 104 and the access request enabling signals 156 to 158, respectively. When one of the masters 100 to 102 issues, to the memory 104, a corresponding one of the access requests 150 to 152 beyond a request bandwidth set to each of the masters 100 to 102, the access request arbitrating unit 105 asserts a corresponding one of request bandwidth excess signals 159 to 161, and notifies the refresh request control unit 106 that the corresponding one of the access requests 150 to 152 has been issued beyond the request bandwidth.

The refresh request control unit 106 issues a refresh request 162, a refresh command 163, an advanced refresh request signal 164, and others, based on the access requests 150 to 152 from the masters 100 to 102 and the result of the arbitration by the access request arbitrating unit 105. More specifically, the refresh request control unit 106 includes a refresh cycle counter 107, a number-of-refresh-issuance counter 108, and a refresh request issuing unit 109. The refresh request control unit 106 issues, to the access request arbitrating unit 105, the refresh request 162, the refresh command 163, the advanced refresh request signal 164, and a refresh cycle counter signal 165 indicating a value of the refresh cycle counter 107. When the access request arbitrating unit 105 enables the refresh request 162, it notifies the refresh request control unit 106 of the enabling of the refresh request 162 using a refresh request enabling signal 166.

The refresh cycle counter 107 is a down counter that decrements a count value corresponding to a set refresh cycle (for example, 10 milli-seconds) as a default value by 1 for each refresh cycle, based on a master clock that is externally provided. The refresh cycle counter 107 provides the refresh cycle counter signal 165 to the access request arbitrating unit 105. Furthermore, the refresh cycle counter 107 asserts a number-of-refresh-issuance counter decrement signal 167 when the value of the refresh cycle counter 107 becomes 1. Furthermore, the value of the refresh cycle counter 107 is reset to the default value at the next cycle.

The number-of-refresh-issuance counter 108 increments a count value by 1 when the access request arbitrating unit 105 asserts the refresh request enabling signal 166, and decrements a count value by 1 when the refresh cycle counter 107 asserts the number-of-refresh-issuance counter decrement signal 167. In other words, the count value of the number-of-refresh-issuance counter 108 indicates the number of times refreshes are issued prior to the refresh cycle. The count value of the number-of-refresh-issuance counter 108 is notified to the refresh request issuing unit 109 using a number-of-refresh-issuance counter signal 168.

The refresh request issuing unit 109 issues the refresh request 162 and the advanced refresh request signal 164 based on the count value of the number-of-refresh-issuance counter 108 notified using the number-of-refresh-issuance counter signal 168 and on the request bandwidth excess signals 159 to 161 respectively corresponding to the masters 100 to 102.

Furthermore, the refresh request issuing unit 109 provides the refresh command 163 to the access request arbitrating unit 105. The refresh command 163 is indicated by a fixed value, and includes (i) a command ID indicating that the access request arbitrating unit 105 needs to issue a refresh to the memory 104 and (ii) information indicating a region of the memory 104 where the refresh is performed.

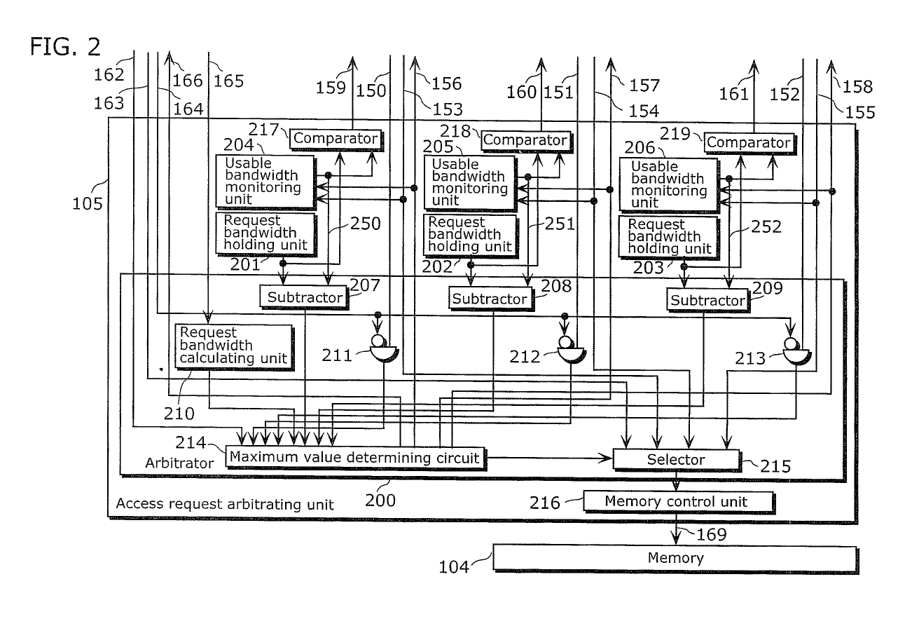

FIG. 2 is a block diagram illustrating a detailed configuration of the access request arbitrating unit 105 in FIG. 1.

The access request arbitrating unit 105 includes an arbitrator 200, request bandwidth holding units 201 to 203, usable bandwidth monitoring units 204 to 206, a memory control unit 216, and comparators 217 to 219.

The arbitrator 200 arbitrates between the access requests 150 to 152 from the masters 100 to 102 and the refresh request 162, based on request bandwidths held by the request bandwidth holding units 201 to 203 set for the masters 100 to 102, usable bandwidths 250 to 252 of the masters 100 to 102 notified from the usable bandwidth monitoring units 204 to 206, respectively, the refresh cycle counter signal 165, and the advanced refresh request signal 164. The arbitrator 200 notifies a result of the arbitration to each of the masters 100 to 102 and the refresh request control unit 106, using a corresponding one of the access request enabling signals 156 to 158 and the refresh request enabling signal 166.

More specifically, the arbitrator 200 includes subtractors 207 to 209, a request bandwidth calculating unit 210, access request mask circuits 211 to 213, a maximum value determining circuit 214, and a selector 215.

For example, the subtractor 207 subtracts the usable bandwidth 250 monitored by the usable bandwidth monitoring unit 204 from the request bandwidth held by the request bandwidth holding unit 201. More specifically, the subtractor 207 calculates (the request bandwidth held by the request bandwidth holding unit 201—the usable bandwidth 250), the subtractor 208 calculates (the request bandwidth held by the request bandwidth holding unit 202—the usable bandwidth 251), and the subtractor 209 calculates (the request bandwidth held by the request bandwidth holding unit 203—the usable bandwidth 252). The subtractors 207 to 209 respectively notify the maximum value determining circuit 214 of results of the calculations.

Here, each of the request bandwidths corresponds to an amount of memory access data per unit time required to smoothly perform processing in a corresponding one of the masters 100 to 102. The request bandwidth is larger in the processing having more frequent memory accesses, whereas the request bandwidth is smaller in the processing having less frequent memory accesses. For example, the masters 100 to 102 have or an operating system has only to set the request bandwidths to the request bandwidth holding units 201 to 203, respectively when they are reset. Furthermore, the masters 100 to 102 or the operating system may dynamically change the respective request bandwidths when a program (task or process) is switched to another. The unit time may be a fixed value, for example, a unit time of processing set in each of the masters 100 to 102, an integral multiple of a frame (field) period of image processing, and an integral multiple of a refresh cycle.

Furthermore, each of the usable bandwidths corresponds to an amount of memory access data per unit time at a current time in response to an access request issued from a corresponding one of the masters 100 to 102. Here, the request bandwidth holding units 201 to 203 correspond to holding units.

The request bandwidth calculating unit 210 calculates a refresh request bandwidth that corresponds to an amount of memory access data per unit time in response to the refresh request 162, using the refresh cycle counter signal 165. More specifically, the request bandwidth calculating unit 210 calculates the refresh request bandwidth, using the refresh cycle counter signal 165 at a current time and an access interruption time occurring in the memory 104 due to the refresh operation.

When the advanced refresh request signal 164 is asserted, the access request mask circuits 211 to 213 respectively negate the access requests 150 to 152 from the masters 100 to 102. When the advanced refresh request signal 164 is negated, the access request mask circuits 211 to 213 respectively provide the access requests 150 to 152 from the masters 100 to 102. The maximum value determining circuit 214 receives the outputs from the access request mask circuits 211 to 213.

The maximum value determining circuit 214 determines one of the refresh request 162 and the access requests 150 to 152 that has the largest value, based on the results of the subtractions in the subtractors 207 to 209 and the result of the calculation in the request bandwidth calculating unit 210, depending on whether or not the refresh request 162 is asserted. Furthermore, the maximum value determining circuit 214 indicates, to the selector 215, a command that corresponds to the determined one of the refresh request 162 and the access requests 150 to 152, from among the refresh command 163 and the access commands 153 to 155.

More specifically, when the refresh request 162 is negated, the maximum value determining circuit 214 compares the results of the subtractions in the subtractors 207 to 209 respectively corresponding to the access request mask circuits 211 to 213 whose outputs are asserted, and determines one of the subtractors 207 to 209 that obtains the largest subtraction result. Then, the maximum value determining circuit 214 asserts one of the access request enabling signals 156 to 158 that corresponds to the determines one of the subtractors 207 to 209 and that is provided to a corresponding one of the masters 100 to 102. Furthermore, the maximum value determining circuit 214 negates the refresh request enabling signal 166.

In contrast, when the refresh request 162 is asserted, the maximum value determining circuit 214 compares the results of the subtractions in the subtractors 207 to 209, and the result of the calculation in the request bandwidth calculating unit 210. Here, the subtractors 207 to 209 respectively correspond to the access request mask circuits 211 to 213 whose outputs are asserted. When the result of the calculation in the request bandwidth calculating unit 210 is the largest as a result of the comparison, the maximum value determining circuit 214 asserts the refresh request enabling signal 166 to be provided to the number-of-refresh-issuance counter 108, and negates the access request enabling signals 156 to 158. When one of the results of the subtractions in the subtractors 207 to 209 is the largest as a result of the comparison, the maximum value determining circuit 214 determines the one of the subtractors 207 to 209, and asserts one of the access request enabling signals 156 to 158 that corresponds to the determined one of the subtractors 207 to 209 and is provided to a corresponding one of the masters 100 to 102.

Thereby, when two or more of the masters 100 to 102 assert the access requests 150 to 152, respectively, the maximum value determining circuit 214 can arbitrate between corresponding ones of the access requests 150 to 152. Furthermore, when the refresh request 162 is asserted while at least one of the masters 100 to 102 asserts a corresponding one of the access requests 150 to 152, the maximum value determining circuit 214 can arbitrate between the refresh request 162 and the corresponding one of the access requests 150 to 152.

The selector 215 provides the memory control unit 216 with one of the refresh command 163 and the access commands 153 to 155 according to a signal indicating a result of the determination by the maximum value determining circuit 214. More specifically, when the maximum value determining circuit 214 determines that the value of one of the subtractors 207 to 209 is the largest, the selector 215 notifies the memory control unit 216 of a corresponding one of the access commands 153 to 155. When the value of the request bandwidth calculating unit 210 is the largest, the selector 215 notifies the memory control unit 216 of the refresh command 163.

The usable bandwidth monitoring units 204 to 206 correspond to the masters 100 to 102, and monitor usable bandwidths of the access commands 153 to 155 issued by the masters 100 to 102, respectively. More specifically, when one of the access request enabling signals 156 to 158 is asserted, a corresponding one of the usable bandwidth monitoring units 204 to 206 calculates the usable bandwidth using the amount of memory access data indicated by a corresponding one of the access commands 153 to 155. For example, the usable bandwidth monitoring units 204 to 206 have only to monitor the usable bandwidths for the masters 100 to 102 by calculating the amounts of memory access data of the access commands 153 to 155 each time the masters 100 to 102 assert the access requests 150 to 152, respectively, and accumulating all the amounts of memory access data of the access commands 153 to 155 that have been issued within the unit time.

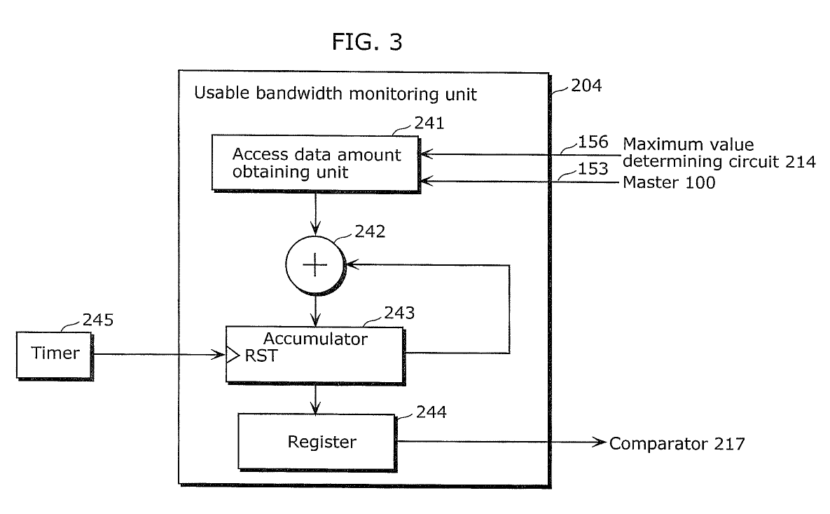

FIG. 3 is a block diagram illustrating an example of a detailed configuration of the usable bandwidth monitoring unit 204. Each of the usable bandwidth monitoring units 205 and 206 has the same configuration. FIG. 3 also illustrates a timer 245 in a circuit outside the usable bandwidth monitoring unit 204.

The usable bandwidth monitoring unit 204 in FIG. 3 includes an access data amount obtaining unit 241, an adder 242, an accumulator 243, and a register 244. When the access request enabling signal 156 is asserted, the access data amount obtaining unit 241 obtains an access data amount indicated by the access command 153. The adder 242 adds the access data amount obtained by the access data amount obtaining unit 241 to an access data amount held in the accumulator 243, and provides a result of the addition to the accumulator 243. The accumulator 243 accumulates the access data amounts from the reset timing controlled by the timer 245 to a current time, and holds a result of the accumulation. Furthermore, when a reset signal fed from the timer 245 is asserted, the accumulator 243 provides the held access data amount to the register 244. Here, the timer 245 asserts the reset signal per predetermined unit time (for example, 1 milli-second).

Thereby, the usable bandwidth monitoring unit 204 can accumulate the access data amounts corresponding to all the access commands 153 that have been issued within the unit time. Here, the usable bandwidth monitoring units 204 to 206 correspond to monitoring units.

When the arbitrator 200 selects one of the access commands 153 to 155 and the refresh command 163, the memory control unit 216 generates an access command and a refresh command for the memory 104 and issues the generated access command and refresh command to the memory 104 using the command communication signal line 169.

The comparators 217 to 219 correspond to the masters 100 to 102, and compare the request bandwidths held by the request bandwidth holding units 201 to 203 with the usable bandwidths 250 to 252 provided by the usable bandwidth monitoring units 204 to 206 at a current time, respectively. When the usable bandwidth exceeds the corresponding request bandwidth, the comparators 217 to 219 respectively assert the request bandwidth excess signals 159 to 161. Here, the comparators 217 to 219 correspond to bandwidth determining units.

As such, when the advanced refresh request signal 164 is asserted, even in the case where the masters 100 to 103 assert the access requests 150 to 152, respectively, the access request arbitrating unit 105 issues a refresh command to the memory 104. Furthermore, when the refresh request 162 and the advanced refresh request signal 164 are negated and at least two of the masters 100 to 102 respectively assert corresponding ones of the access requests 150 to 152, the access request arbitrating unit 105 arbitrates between the corresponding ones of the access requests 150 to 152 based on each difference between the request bandwidth of the access request at a current time and a corresponding one of the usable bandwidths 250 to 252. Furthermore, when the refresh request 162 is asserted, the advanced refresh request signal 164 is negated, and at least one of the masters 100 to 102 asserts a corresponding one of the access requests 150 to 152, the access request arbitrating unit 105 arbitrates between the corresponding one of the access requests 150 to 152 and the refresh request 162, based on a refresh request bandwidth held by a corresponding one of the request bandwidth holding units 201 to 203.

Here, the refresh request control unit 106, the arbitrator 200, and the memory control unit 216 corresponds to a control unit.

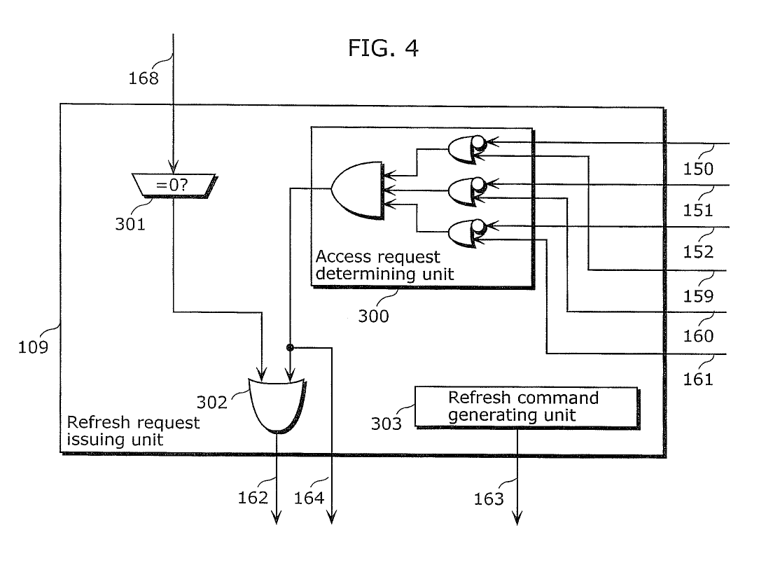

FIG. 4 is a block diagram illustrating a detailed configuration of the refresh request issuing unit 109 in FIG. 1. The refresh request issuing unit 109 includes an access request determining unit 300, a comparator 301, a combinational circuit 302, and a refresh command generating unit 303.

The access request determining unit 300 asserts the access requests 150 to 152, and determines whether or not any one of the masters 100 to 102 negates the request bandwidth excess signals 159 to 161. In other words, when one of the masters 100 to 102 issues an access request and a corresponding one of the usable bandwidths 250 to 252 does not exceed the request bandwidth, the access request determining unit 300 determines that the one of the masters 100 to 102 issues the access request and negates the output. Furthermore, when none of the masters 100 to 102 issues an access request or when one of the masters 100 to 102 issues an access request but a corresponding one of the usable bandwidths 250 to 252 exceeds the request bandwidth, the access request determining unit 300 determines that none of the masters 100 to 102 issues the access request and asserts the output. Here, the access request determining unit 300 transmits the advanced refresh request signal 164 corresponding to the output.

The comparator 301 determines whether or not the number-of-refresh-issuance counter signal 168, that is, the count value of the number-of-refresh-issuance counter 108 becomes a reference value. For example, when the reference value is 0 and the number-of-refresh-issuance counter signal 168 indicates 0, the comparator 301 asserts the output. In contrast, when the reference value is other than 0 and the number-of-refresh-issuance counter signal 168 indicates other than 0, the comparator 301 negates the output.

The combinational circuit 302 asserts and negates the refresh request 162, based on results of the access request determining unit 300 and the comparator 301. More specifically, when the count value of the number-of-refresh-issuance counter 108 is 0 or when the access request determining unit 300 determines that none of the masters 100 to 102 issues an access request, the combinational circuit 302 asserts the refresh request 162. When the count value of the number-of-refresh-issuance counter 108 is not 0 and the access request determining unit 300 determines that one of the masters 100 to 102 issues an access request to the refresh request issuing unit 109, the combinational circuit 302 negates the refresh request 162.

The refresh command generating unit 303 provides the refresh command 163 to the access request arbitrating unit 105. The refresh command 163 is indicated by a fixed value that is determined by (i) the command ID indicating that the refresh command generating unit 303 sets the command and (ii) information indicating a region of the memory 104 where the refresh is performed. Here, the information set in the refresh command generating unit 303 may either be fixed as hardware or set by software.

As such, the refresh request issuing unit 109 asserts or negates the refresh request 162 and the advanced refresh request signal 164, based on the number-of-refresh-issuance counter signal 168, the access requests 150 to 152, and the request bandwidth excess signals 159 to 161. Furthermore, the refresh request issuing unit 109 provides the refresh command 163 to the access request arbitrating unit 105.

Since the refresh commands issued in advance with the configuration can be larger than the refresh commands issued in advance only when all the masters 100 to 102 negate the access requests 150 to 152, respectively, the efficiency of access to the memory 104 can be further improved.

Here, the refresh cycle counter 107, the selector 215, the memory control unit 216, the comparator 301, the combinational circuit 302, and the refresh command generating unit 303 correspond to a normal refresh control unit.

Furthermore, the comparator 301 and the combinational circuit 302 also correspond to a refresh request issuing unit, while the arbitrator 200 and the memory control unit 216 also correspond to an arbitrator.

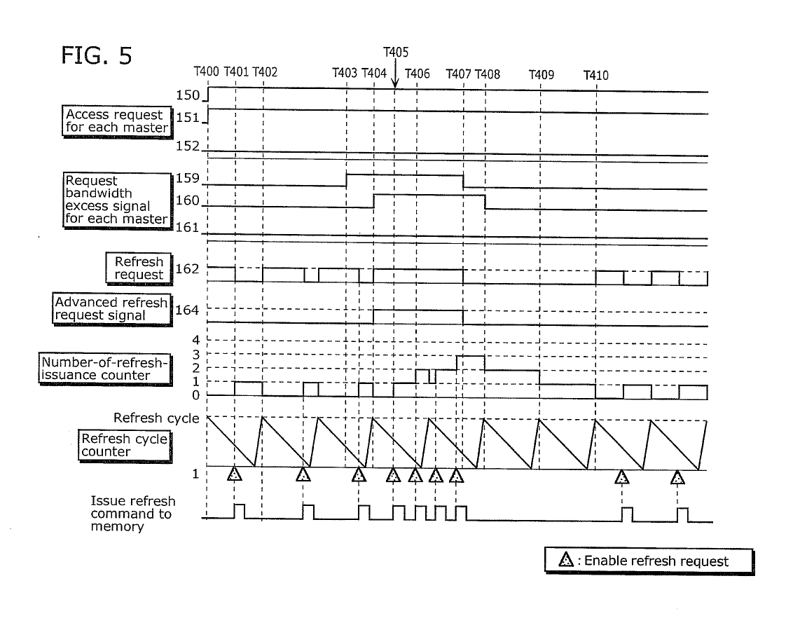

Next, operations of the memory control apparatus 103 described hereinbefore will be described. FIG. 5 illustrates a timing chart indicating an example of the operations of the memory control apparatus 103 according to Embodiment 1.

Although the masters 100 and 101 assert the access requests 150 and 151 to the memory 104 at T400, the corresponding request bandwidth excess signals 159 and 160 are negated. Thus, the advanced refresh request signal 164 is negated. Furthermore, since the count value of the number-of-refresh-issuance counter 108 is 0, the refresh request issuing unit 109 asserts the refresh request 162. Furthermore, at T400, the value of the refresh cycle counter 107 is a value corresponding to the refresh cycle, and is a default value.

Next at T401, the access request arbitrating unit 105 asserts the refresh request enabling signal 166 in response to the refresh request 162. With the enabling of the refresh request 162, the memory control unit 216 issues a refresh command to the memory 104. Furthermore, with the assertion of the refresh request enabling signal 166, 1 is added to the count value of the number-of-refresh-issuance counter 108, and the value is changed from 0 to 1. Furthermore, with the change in the count value of the number-of-refresh-issuance counter 108 to 1, the refresh request 162 is negated.

Next, since the value of the refresh cycle counter 107 becomes 1 in one immediately previous cycle, the value of the refresh cycle counter 107 is reset to a value corresponding to the refresh cycle, and is a default value at T402. With the reset of the value of the refresh cycle counter 107, 1 is subtracted from the count value of the number-of-refresh-issuance counter 108 and the value is changed from 1 to 0. Furthermore, with the change in the count value of the number-of-refresh-issuance counter 108 to 0, the refresh request issuing unit 109 asserts the refresh request 162.

Next, the processing at T401 and T402 is repeated at T402 to T403.

Next, at T403, the request bandwidth excess signal 159 is asserted which indicates a state where the master 100 has issued the access request 150 in a state of exceeding the request bandwidth.

Next, at T404, the request bandwidth excess signal 160 is asserted which indicates that the master 101 has issued the access request 151 in a state of exceeding the request bandwidth. Here, while the master 100 asserts the access request 150 and the access request arbitrating unit 105 asserts the request bandwidth excess signal 159, the master 101 asserts the access request 151 and the access request arbitrating unit 105 asserts the request bandwidth excess signal 160. Furthermore, the master 102 does not assert the access request 152. Accordingly, when the access request determining unit 300 determines that none of the masters 100 to 102 issues an access request to the refresh request issuing unit 109, the advanced refresh request signal 164 is asserted, and the refresh request 162 is also asserted.

Next at T405, the access request arbitrating unit 105 asserts the refresh request enabling signal 166. Here, since the advanced refresh request signal 164 is asserted, the access request arbitrating unit 105 enables the refresh request 162 as the highest priority. With the assertion of the refresh request enabling signal 166, 1 is added to the count value of the number-of-refresh-issuance counter 108, and the value is changed from 0 to 1. Here, the access request determining unit 300 determines that none of the masters 100 to 102 issues an access request to the refresh request issuing unit 109. Thus, although the count value of the number-of-refresh-issuance counter 108 is not smaller than 1, the refresh request 162 continues to be asserted.

Next at T406, the access request arbitrating unit 105 asserts the refresh request enabling signal 166. With the assertion of the refresh request enabling signal 166, 1 is added to the count value of the number-of-refresh-issuance counter 108, and the value is changed from 1 to 2. Since the access request determining unit 300 determines that none of the masters 100 to 102 issues an access request to the refresh request issuing unit 109, the refresh request 162 continues to be asserted.

Next at T407, the request bandwidth excess signal 159 is negated for the master 100. Since the master 100 has issued the access request 150, the access request determining unit 300 determines that the refresh request issuing unit 109 asserts the access request 150 from the master 100. Thus, the advanced refresh request signal 164 is negated. Furthermore, at T407, since the count value of the number-of-refresh-issuance counter 108 is 3 that is larger than 1, the refresh request 162 is also negated.

Next at T408, since the value of the refresh cycle counter 107 becomes 1 in one immediately previous cycle, the value of the refresh cycle counter 107 is reset to a value corresponding to the refresh cycle, and is a default value. With the reset of the value of the refresh cycle counter 107, 1 is subtracted from the count value of the number-of-refresh-issuance counter 108 and the value is changed from 3 to 2. Here, although the access request determining unit 300 determines that the count value of the number-of-refresh-issuance counter 108 is not smaller than 1 and the master 100 issues an access request to the refresh request issuing unit 109, the refresh request 162 continues to be negated.

Next at T409, although 1 is subtracted from the count value of the number-of-refresh-issuance counter 108 and the value is changed from 2 to 1, the access request determining unit 300 determines that the count value of the number-of-refresh-issuance counter 108 is not smaller than 1 and the master 100 issues an access request to the refresh request issuing unit 109. Thus, the refresh request 162 continues to be negated.

Next, since the value of the refresh cycle counter 107 becomes 1 in one immediately previous cycle, the value of the refresh cycle counter 107 is reset to a value corresponding to the refresh cycle, and is a default value at T410. With the reset of the value of the refresh cycle counter 107, 1 is subtracted from the count value of the number-of-refresh-issuance counter 108 and the value is changed from 1 to 0. With the change in the count value of the number-of-refresh-issuance counter 108 to 0, the refresh request 162 is asserted.

As illustrated in FIG. 5, during T404 to T407, while the masters 100 and 101 respectively assert the access requests 150 and 151, the access request arbitrating unit 105 asserts the request bandwidth excess signals 159 and 160. As a result, since the access request determining unit 300 determines that none of the access requests 150 and 151 is issued, the refresh request issuing unit 109 asserts the advanced refresh request signal 164. Thereby, even when the masters 100 and 101 respectively issue the access requests 150 and 151, the refresh request issuing unit 109 can issue the refresh command 163.

Furthermore, since the count value of the number-of-refresh-issuance counter 108 is not smaller than 1 during T407 to T410, no refresh command is issued to the memory 104. Thus, the efficiency of access from the masters 100 and 101 that have issued the access requests to the memory 104 can be further improved during T407 to T410.

As such, the number of advanced refresh commands issued by the memory control apparatus 103 prior to a period when no normal refresh command is issued (T408 to T410) is not smaller than the number of normal refresh commands that should be issued during the period (two). As a result, volatilization of data due to the lack of refresh can be prevented.

As described above, when at least one of the masters 100 to 102 assert the access requests 150 to 152, the memory control apparatus 103 according to Embodiment 1 issues an advanced refresh command based on a usable bandwidth and the corresponding request bandwidth for each of the masters 100 to 102. Thus, the efficiency of access from the masters 100 and 102 to the memory 104 due to issuance of a refresh command in synchronization with a refresh cycle can be further improved.

Although Embodiment 1 describes the example that the comparator 301 asserts the output when the number-of-refresh-issuance counter signal 168 indicates 0 while the comparator 301 negates the output when the number-of-refresh-issuance counter signal 168 indicates other than 0, the value asserted by the comparator 301 may be selected either as 0 or 1. Furthermore, the value may be freely set according to the number of masters and the refresh cycle of the memory.

### Embodiment 2

A memory control apparatus according to Embodiment 2 in the present invention does not issue any advanced refresh command to a memory 104 when the count value of a number-of-refresh-issuance counter 108 is not smaller than a predetermined threshold larger than a reference value.

Although the configuration of the memory control apparatus according to Embodiment 2 is the same as that of the memory control apparatus according to Embodiment 1, the configuration of the refresh request issuing unit differs. The differences in the memory control apparatus between Embodiments 1 and 2 will be mainly described hereinafter.

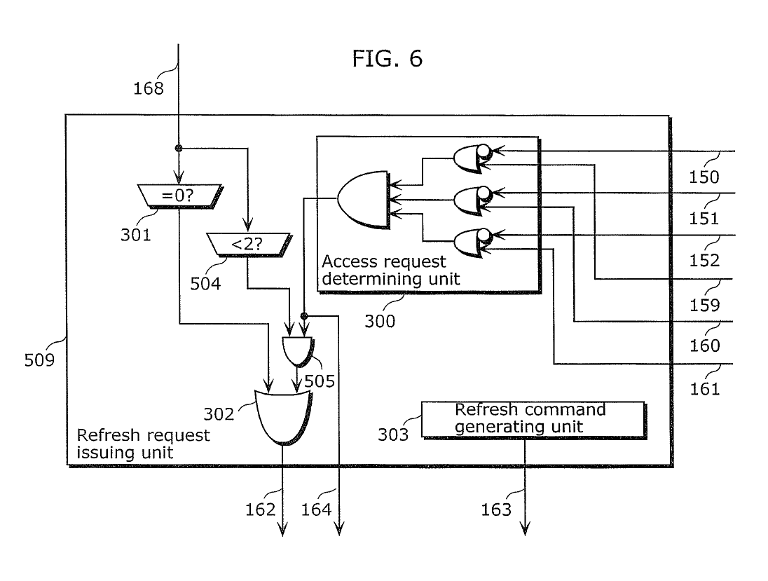

FIG. 6 is a block diagram illustrating a detailed configuration of a refresh request issuing unit 509 according to Embodiment 2. The refresh request issuing unit 509 further includes a comparator 504 and a combinational circuit 505, in addition to the configuration of the refresh request issuing unit 109 according to Embodiment 1. An access request determining unit 300, a comparator 301, a combinational circuit 302, and a refresh command generating unit 303 are the same as those in FIG. 4. Furthermore, an advanced refresh request signal 164 is the same as that in FIG. 4.

The comparator 504 asserts the output when a number-of-refresh-issuance counter signal 168 indicates a value smaller than the predetermined threshold larger than the reference value (for example, 2), while it negates the output when the number-of-refresh-issuance counter signal 168 indicates a value not smaller than the threshold.

The combinational circuit 505 ANDs an output from the comparator 504 and an output from the access request determining unit 300. Furthermore, the combinational circuit 302 ORs an output from the combinational circuit 505 and an output from the comparator 301, and provides the result to an access request arbitrating unit 105 as a refresh request 162.

Thereby, the refresh request issuing unit 509 negates the refresh request 162 when the number-of-refresh-issuance counter signal 168 indicates a value not smaller than 2, regardless of the determination result of the access request determining unit 300.

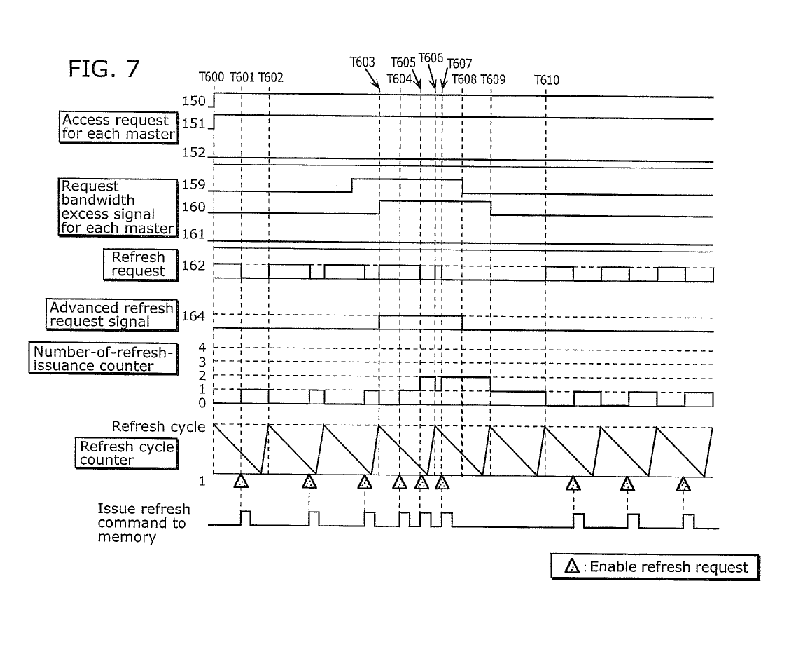

FIG. 7 illustrates a timing chart indicating an example of operations of the memory control apparatus according to Embodiment 2. Access requests 150 to 152 and request bandwidth excess signals 159 and 160 in FIG. 7 are the same as those in FIG. 5. When the count value of the number-of-refresh-issuance counter 108 is 0, or when the count value of the number-of-refresh-issuance counter 108 is not smaller than 1 and smaller than 2 and the access request determining unit 300 determines that none of the masters issues an access request, the refresh request 162 is asserted. Otherwise, the refresh request 162 is negated.

First at T600, the masters 100 and 101 assert the access requests 150 and 151 to the memory 104, respectively. Furthermore, the access request arbitrating unit 105 negates the corresponding request bandwidth excess signals 159 and 160. Thus, the refresh request issuing unit 509 negates the advanced refresh request signal 164. Furthermore, since the count value of the number-of-refresh-issuance counter 108 is 0, the refresh request issuing unit 509 asserts the refresh request 162. Furthermore, at T600, the value of a refresh cycle counter 107 is a value corresponding to the refresh cycle, and is a default value.

Next at T601, the access request arbitrating unit 105 asserts a refresh request enabling signal 166. With the assertion of the refresh request enabling signal 166, 1 is added to the count value of the number-of-refresh-issuance counter 108, and the value is changed from 0 to 1. With the change in the count value of the number-of-refresh-issuance counter 108 to 1 in a state where the masters 100 and 101 respectively assert the access requests 150 and 151, the refresh request 162 is negated.

Next at T602, since the value of the refresh cycle counter 107 becomes 1 in one immediately previous cycle, it is reset to a value corresponding to the refresh cycle, and is a default value. With the reset of the value of the refresh cycle counter 107, 1 is subtracted from the count value of the number-of-refresh-issuance counter 108 and the value is changed from 1 to 0. Furthermore, with the change in the count value of the number-of-refresh-issuance counter 108 to 0, the refresh request 162 is asserted.

Next at T603, the request bandwidth excess signal 160 is asserted which indicates a state where the master 101 has issued the access request 151 in a state of exceeding the request bandwidth. Furthermore, the master 102 does not assert the access request 152. Prior to T603, the request bandwidth excess signal 159 is asserted which indicates a state where the master 100 has issued the access request 150 in a state of exceeding the request bandwidth.

Since the access request determining unit 300 determines that none of the masters 100 to 102 issues an access request to the refresh request issuing unit 509, the advanced refresh request signal 164 is asserted. Furthermore, since the count value of the number-of-refresh-issuance counter 108 is 0, the refresh request 162 is asserted.

Next at T604, the access request arbitrating unit 105 asserts the refresh request enabling signal 166. With the assertion of the refresh request enabling signal 166, 1 is added to the count value of the number-of-refresh-issuance counter 108, and the value is changed from 0 to 1. Here, the access request determining unit 300 determines that none of the masters 100 to 102 issues an access request to the refresh request issuing unit 509 as at T603. Thus, the advanced refresh request signal 164 continues to be asserted. Furthermore, since the count value of the number-of-refresh-issuance counter 108 is 1, the refresh request 162 continues to be asserted.

Next at T605, the access request arbitrating unit 105 asserts the refresh request enabling signal 166. With the assertion of the refresh request enabling signal 166, 1 is added to the count value of the number-of-refresh-issuance counter 108, and the value is changed to 2. Here, since the access request determining unit 300 determines that none of the masters 100 to 102 issues an access request to the refresh request issuing unit 109, the advanced refresh request signal 164 continues to be asserted. In contrast, since the count value of the number-of-refresh-issuance counter 108 does not satisfy a condition of not smaller than 1 and smaller than 2, the refresh request 162 is negated.

Next at T606, since the value of the refresh cycle counter 107 becomes 1 in one immediately previous cycle, it is reset to a value corresponding to the refresh cycle, and is a default value. With the reset of the value of the refresh cycle counter 107, 1 is subtracted from the count value of the number-of-refresh-issuance counter 108 and the value is changed from 2 to 1. Here, since the access request determining unit 300 determines that none of the masters 100 to 102 issues an access request to the refresh request issuing unit 509 and the count value of the number-of-refresh-issuance counter 108 satisfies the condition of not smaller than 1 and smaller than 2, the refresh request 162 is asserted.

Next at T607, the access request arbitrating unit 105 asserts the refresh request enabling signal 166. With the assertion of the refresh request enabling signal 166, 1 is added to the count value of the number-of-refresh-issuance counter 108, and the value is changed to 2. Here, since the access request determining unit 300 determines that none of the masters 100 to 102 issues an access request to the refresh request issuing unit 509, the advanced refresh request signal 164 continues to be asserted. Furthermore, since the count value of the number-of-refresh-issuance counter 108 does not satisfy the condition of not smaller than 1 and smaller than 2, the refresh request 162 is negated again.

Next at T608, the request bandwidth excess signal 159 is negated for the master 100. Since the master 100 has issued the access request 150 and the request bandwidth excess signal 159 is negated, the access request determining unit 300 determines that the refresh request issuing unit 509 asserts the access request 150 from the master 100. Thus, the advanced refresh request signal 164 is negated. Furthermore, since the count value of the number-of-refresh-issuance counter 108 is 2, the refresh request 162 continues to be negated.

Next at T609, 1 is subtracted from the count value of the number-of-refresh-issuance counter 108 and the value is changed from 2 to 1. Although the count value of the number-of-refresh-issuance counter 108 is not smaller than 1 and smaller than 2, since the master 100 has issued the access request 150, the refresh request 162 continues to be negated.

Next at T610, since the value of the refresh cycle counter 107 becomes 1 in one immediately previous cycle, it is reset to a value corresponding to the refresh cycle, and is a default value. With the reset of the value of the refresh cycle counter 107, 1 is subtracted from the count value of the number-of-refresh-issuance counter 108 and the value is changed from 1 to 0. With the change in the count value of the number-of-refresh-issuance counter 108 to 0, the refresh request 162 is asserted.

As described above, the memory control apparatus according to Embodiment 2 prohibits the issuance of a refresh command to the memory 104 when the count value of the number-of-refresh-issuance counter 108 is not smaller than the threshold. Thereby, the memory control apparatus issues a refresh command to the memory 104 at least once at a time obtained by multiplying, by the refresh cycle, the value obtained by adding 1 to the threshold. As a result, the volatilization of data due to the lack of refresh at the memory 104 for a long period of time can be prevented.

Although Embodiment 2 exemplifies a case where the threshold in the comparator 504 is 2, the threshold may be set to a value not smaller than 3 according to the number of the masters and the refresh cycle of the memory. Furthermore, the value asserted by the comparator 301 is not limited to 0 as in Embodiment 1.

Furthermore, the aforementioned memory control apparatus may be applied to various information processing apparatuses and systems.

### Embodiment 3

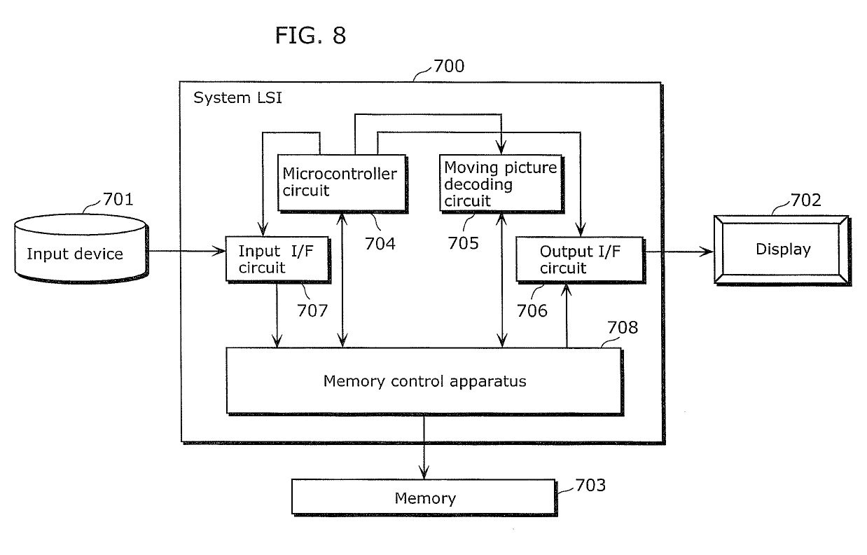

FIG. 8 is a block diagram illustrating a configuration of a system according to Embodiment 3.

The system in FIG. 8 includes a system LSI 700, an input device 701 such as a DVD drive, a display 702 such as a liquid crystal display, and a memory 703.

The system LSI 700 includes a microcontroller circuit 704, a moving picture decoding circuit 705, an output interface (I/F) circuit 706, an input interface (I/F) circuit 707, and a memory control apparatus 708. The memory control apparatus 708 is one of the memory control apparatus 103 in Embodiment 1 and the memory control apparatus in Embodiment 2.

Each of the microcontroller circuit 704, the moving picture decoding circuit 705, the output interface circuit 706, and the input interface circuit 707 is connected to the memory control apparatus 708. Furthermore, the microcontroller circuit 704 is connected to each of the moving picture decoding circuit 705, the output interface circuit 706, and the input interface circuit 707, so that it can control each circuit connected thereto.

The output interface circuit 706 is connected to the display 702, the input interface circuit 707 is connected to the input device 701, and the memory control apparatus 708 is connected to the memory 703.

In the system of FIG. 8, the microcontroller circuit 704 executes a program stored in the memory 703 while reading the program, so that it controls the moving picture decoding circuit 705, the output interface circuit 706, and the input interface circuit 707. Thereby, the input interface circuit 707 loads moving picture stream data from the input device 701 into the memory 703. Then, the moving picture decoding circuit 705 decodes the moving picture stream data loaded into the memory 703 to generate picture data, and writes the decoded picture data into the memory 703. The output interface circuit 706 reads the picture data written into the memory 703 and displays it on the display 702.

The input interface circuit 707 corresponds to a first master, the moving picture decoding circuit 705 corresponds to a second master, and the output interface circuit 706 corresponds to a third master.

Here, there are cases where each of the moving picture decoding circuit 705, the output interface circuit 706, and the input interface circuit 707 frequently accesses the memory 703 in each processing locally, and conversely where they do not access the memory 703 for a certain period of time. For example, the output interface circuit 706 locally reads data from the memory 703 according to a frequency displayed on the display 702. After the output interface circuit 706 reads data corresponding to pictures to be displayed on the display 702, it does not issue an access request to the memory 703 until the next reading of pictures. In other words, there are cases where an access request is issued over the request bandwidth and where an access request is not continuously issued for a certain period of time. With the configuration according to Embodiment 3, since the masters access the memory 703 using the memory control apparatus 708, an efficient refresh operation can be performed on the memory 703.

As described above, the efficient refresh operation can be performed on a memory and the system performance can be increased in a state where masters access the memory according to Embodiment 3.

### Embodiment 4

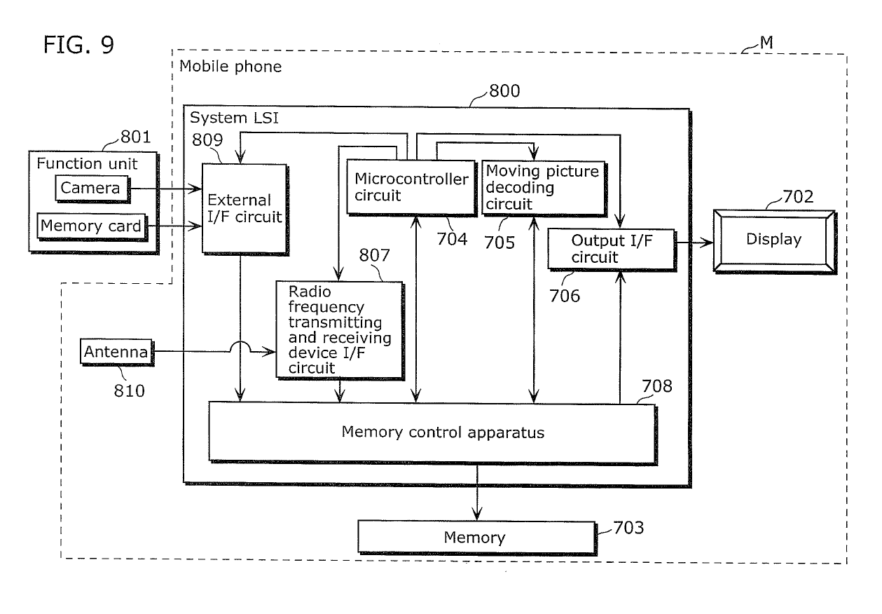

Although Embodiment 3 describes an example of the system including the input device 701 such as a DVD drive, and the display 702 such as a liquid crystal display, the present invention may be applicable to a mobile phone. FIG. 9 illustrates a configuration of the applied mobile phone.

The system in FIG. 9 includes a function unit 801 and a mobile phone M. The function unit 801 includes a camera and a memory card, and holds coded data. The mobile phone M includes a display 702, a memory 703, and a system LSI 800, and an antenna 810.

The system LSI 800 includes a microcontroller circuit 704, a moving picture decoding circuit 705, an output interface circuit 706, a radio frequency transmitting and receiving device interface circuit 807, an external interface (I/F) circuit 809, and a memory control apparatus 708. The memory control apparatus 708 is one of the memory control apparatuses in Embodiments 1 and 2. Each of the microcontroller circuit 704, the moving picture decoding circuit 705, the output interface circuit 706, the radio frequency transmitting and receiving device interface circuit 807, and the external interface circuit 809 is connected to the memory control apparatus 708. The microcontroller circuit 704 is connected to each of the moving picture decoding circuit 705, the output interface circuit 706, the radio frequency transmitting and receiving device interface circuit 807, and the external interface circuit 809, so that it can control each circuit connected thereto.

The output interface circuit 706 is connected to the display 702, the radio frequency transmitting and receiving device interface circuit 807 is connected to the antenna 810, the external interface circuit 809 is connected to the function unit 801, and the memory control apparatus 708 is connected to the memory 703.

In the system of FIG. 9, the microcontroller circuit 704 executes a program stored in the memory 703 while reading the program, so that it controls the moving picture decoding circuit 705, the output interface circuit 706, the radio frequency transmitting and receiving device interface circuit 807, and the external interface circuit 809. Thereby, either the external interface circuit 809 loads moving picture stream data from the function unit 801 into the memory 703, or the radio frequency transmitting and receiving device interface circuit 807 loads the moving picture stream data from the antenna 810 into the memory 703. Then, the moving picture decoding circuit 705 decodes the moving picture stream data read into the memory 703 to generate picture data, and writes the decoded picture data into the memory 703. The output interface circuit 706 reads the picture data written into the memory 703 and displays it on the display 702.

Here, the radio frequency transmitting and receiving device interface circuit 807 and the external interface circuit 809 correspond to a first master.

Here, there are cases where each of the moving picture decoding circuit 705, the output interface circuit 706, the radio frequency transmitting and receiving device interface circuit 807, and the external interface circuit 809 frequently accesses the memory 703 in each processing locally, and conversely where they do not access the memory 703 for a certain period of time. As described above, the efficient refresh operation can be performed on the memory 703 and the system performance can be increased with the access to the memory 703 using the memory control apparatus 708 according to Embodiment 4.

The present invention may be applicable to a television receiver. In such a case, a memory card or others is used as the function unit, and a satellite antenna, a ground wave antenna, and other cables are used as the antenna 810 according to the present invention. The antenna 810 receives, for example, digital broadcast waves. Furthermore, the radio frequency transmitting and receiving device interface circuit 807 writes coded data separate from the digital broadcast waves received by the antenna 810 into the memory 703. The coded data is data including a picture.

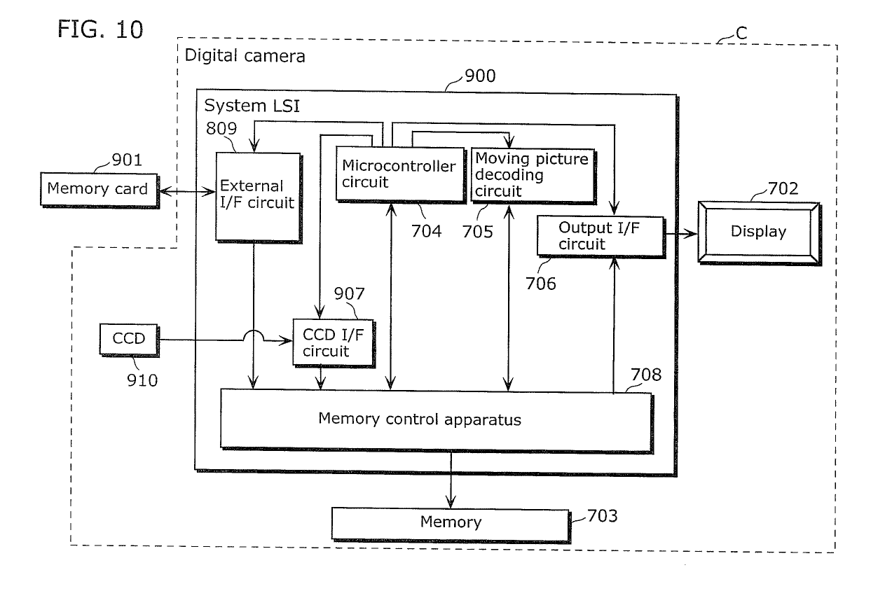

Furthermore, the present invention is applicable to a digital camera. FIG. 10 is a block diagram illustrating a configuration when the present invention is applied to a digital camera. A digital camera C includes the display 702, the memory 703, a system LSI 900, and a Charge Coupled Device (CCD) 910. In such a case, input devices to the system LSI 900 include a memory card 901 and the CCD 910, and the system LSI 900 includes the external interface circuit 809 and a CCD interface (I/F) circuit 907 as interfaces to the memory card 901 and the CCD 910, respectively. The CCD 910 is an image sensor that images an object and provides imaging data. The CCD interface circuit 907 writes the imaging data provided from the CCD 910, into the memory 703. Here, the CCD interface circuit 907 corresponds to a fourth master.

Although the present invention is hereinbefore described based on Embodiments 1 to 4, the present invention is not limited to these embodiments. Without departing from the scope of the present invention, the present invention includes an embodiment with some modifications on Embodiments that would have been conceived by a person skilled in the art, and another embodiment obtained through combinations of the constituent elements of different Embodiments in the present invention.

For example, although the number of masters is 3 in Embodiments 1 and 2, the number of masters may be any number not smaller than 2. Furthermore, although the number of memories is 1 in Embodiments 1 to 3, the number of memories may be any number. Obviously, the memories that require refresh operations, such as an SDR-SDRAM, a DDR-SDRAM, and an FCRAM are used as the memories in Embodiments 1 to 3.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

As described above, the memory control apparatus according to an implementation of the present invention is connected to masters and a memory shared by the masters and controls access from the masters to the memory in response to access requests issued from the masters. The memory control apparatus is applicable to, for example, a DVD recorder, a mobile phone, a television receiver, and a digital camera.

What is claimed is:

1. A memory control apparatus connected to a plurality of masters that issue access requests and to a memory shared by the masters, said memory control apparatus controlling access from the masters to the memory in response to the access requests, and comprising:
a monitoring unit configured to monitor, for each of the masters, a usable bandwidth indicating an amount of memory access data to be accessed per unit time in response to a corresponding one of the access requests from the master;
a holding unit configured to hold a predetermined request bandwidth for each of the masters;
a bandwidth determining unit configured to determine whether or not the usable bandwidth has reached the predetermined request bandwidth for each of the masters; and
a control unit configured to issue an advanced refresh command to the memory based on a result of the determination by said bandwidth determining unit for each of the masters, regardless of timing of a refresh cycle.

2. The memory control apparatus according to claim 1,
wherein said control unit is configured to:
determine, when said bandwidth determining unit determines that the usable bandwidth has reached the predetermined request bandwidth, that a corresponding one of the masters does not assert the access request; and
issue the advanced refresh command to the memory when determining that none of the masters asserts the access requests.

3. The memory control apparatus according to claim 2,
wherein said control unit includes:
a normal refresh control unit configured to periodically issue, to the memory, a normal refresh command for refreshing the memory; and
a number-of-refresh-issuance counter that decrements a count value by 1 for each refresh cycle, increments a count value by 1 when said normal refresh control unit issues the normal refresh command, and increments a count value by 1 when said control unit issues the advanced refresh command, and
said normal refresh control unit is configured:
to issue the normal refresh command when the count value of said number-of-refresh-issuance counter becomes a reference value; and
not to issue the normal refresh command when the count value of said number-of-refresh-issuance counter is not the reference value.

4. The memory control apparatus according to claim 3,
wherein said control unit is configured to prohibit the issuance of the advanced refresh command when the count value of said number-of-refresh-issuance counter is equal to or larger than a threshold larger than the reference value.

5. The memory control apparatus according to claim 1,
wherein said control unit includes:
a refresh request issuing unit configured to periodically issue a normal refresh request for refreshing the memory; and
an arbitrating unit configured to arbitrate between the normal refresh request and each of the access requests issued by the masters, based on (i) a difference between the usable bandwidth and the predetermined request bandwidth for each of the masters and (ii) a refresh request bandwidth indicating an amount of memory access data to be accessed per unit time in response to the normal refresh request from a corresponding one of the masters, and to issue a command to the memory according to a result of the arbitration.

6. An information processing apparatus, comprising:
a semiconductor integrated circuit including said memory control apparatus and the masters according to claim 1; and
the memory connected to said semiconductor integrated circuit and requiring a refresh operation, and
the masters including:
a first master that writes externally provided coded data into the memory;
a second master that decodes the coded data written into the memory and writes the decoded data into the memory; and
a third master that obtains the decoded data from the memory and provides the obtained decoded data to a display.

7. The information processing apparatus according to claim 6,
wherein the first master writes the coded data separate from digital broadcast waves into the memory.

8. The information processing apparatus according to claim 7,
wherein the coded data is data including a picture.

9. The information processing apparatus according to claim 6, further comprising:
an image sensor that images an object and provides imaging data; and
a fourth master that writes the provided imaging data into the memory,
wherein the second master further obtains the imaging data from the memory, codes the obtained imaging data, and writes the coded imaging data into the memory,
the third master further obtains the imaging data from the memory, and provides the obtained imaging data to a display, and
the first master obtains the coded imaging data from the memory, and records the obtained coded imaging data onto a recording medium.
